(19) United States
(12) Patent Application Publication
(10) Pub. No.: US 2014/0039934 A1
(43) Pub. Date: Feb. 6, 2014

(54) INSURANCE VERIFICATION SYSTEM (INSVSYS)

(71) Applicant: Gabriel Ernesto RIVERA, Miami, FL (US)

(72) Inventor: Gabriel Ernesto RIVERA, Miami, FL (US)

(73) Assignee: Gabriel Ernesto RIVERA, Miami, FL (US)

(21) Appl. No.: 13/564,144

(22) Filed: Aug. 1, 2012

(51) Int. Cl. G06Q 40/08

(52) U.S. Cl. 705/4

(57) ABSTRACT

A method and system for verifying insurance information associated with an entity is disclosed. Insurance information is stored in an insurance information repository. An insurance information verification request from a third party computer is received. The insurance information verification request includes a parameter associated with the entity. A determination is made as to whether insurance information associated with the entity includes an insurance policy. If it is determined that the insurance information associated with the entity includes the insurance policy, a policy status of the insurance policy is determined, and a verification message verifying that the insurance information associated with the entity includes the insurance policy is transmitted to the third party computer. The verification message may include the policy status. Else, an alert message is transmitted to the third party computer. The alert message indicates that the entity does not have insurance.

### CROSS-REFERENCE TO RELATED APPLICATION

n/a

### STATEMENT REGARDING FEDERALLY SPONSORED RESEARCH OR DEVELOPMENT

n/a

### TECHNICAL FIELD

The present invention relates to a method and system for verifying insurance information.

### BACKGROUND

The accurate storage, retrieval and providing of personal information has become an important aspect of modern life. A person continuously provides personal information, such as a telephone number, home address, age, driver license, etc., to many different requesters. The requesters may be employers, government authorities, retailers, financial institutions, insurance companies, etc. It is cumbersome to provide the same personal information over and over again to different requesters. For example, a person who wants to purchase an insurance policy may wish to provide the same insurance information, e.g., policy limits, insurance deductible, insurance coverage, etc., to different insurance carriers in order to compare rates.

Additionally, it is inefficient both for (i) the provider of the information to procure the same information again and again to each different requester, and (ii) for each requester to spend time and resources collecting and storing the same information. Many times the person may send the personal information electronically to each requester. However, each requester may request a different set of insurance information, which may require a person to customize the insurance information for every requester. Further, repeatedly providing the same information to different requesters may also increase the chance that one of the requesters receiving the information may enter the information incorrectly in their systems.

It is desirable to have a method and system that allows insurance information to be conveniently stored and provided to third parties.

### SUMMARY

The present invention advantageously provides a method and system for verifying insurance information associated with an entity, the insurance information stored in an insurance information repository. In accordance with one aspect, a method for verifying insurance information is provided. An insurance information verification request from a third party computer is received. The insurance verification request includes a parameter associated with the entity. A determination is made as to whether insurance information associated with the entity includes an insurance policy. When the insurance information associated with the entity includes the insurance policy, a policy status of the insurance policy is determined, and a verification message verifying that the insurance information associated with the entity includes the insurance policy is transmitted to the third party computer. The verification message includes the policy status. When the insurance information associated with the entity does not include the insurance policy, an alert message is transmitted to the third party computer. The alert message indicates that the entity does not have insurance.

In accordance with another aspect, an insurance verification computer for verifying insurance information associated with an entity is provided. The insurance verification computer includes a transmitter, a memory, a receiver and a processor in communication with each other. The memory is configured to store an insurance information repository that includes insurance information. The receiver is configured to receive an insurance information verification request from a third party computer. The insurance information verification request includes a parameter associated with the entity. The processor is configured to determine whether the insurance information associated with the entity includes an insurance policy. When the processor determines that insurance information associated with the entity includes the insurance policy, the processor determines a policy status of the insurance policy, and the transmitter transmits to the third party computer a verification message verifying that the insurance information associated with the entity includes the insurance policy. The verification message includes the policy status. When the processor determines that insurance information associated with the entity does not include the insurance policy, the transmitter transmits an alert message to the third party computer. The alert message indicates that the entity does not have insurance.

In accordance with yet another aspect, a system for verifying insurance information associated with an entity is provided. The system includes an insurance information repository, an insurance verification computer in communication with the insurance information repository, and a third party computer in communication with the insurance verification computer. The third party computer includes a third party transmitter. The third party transmitter is configured to send an insurance information verification request to the insurance verification computer. The insurance information verification request includes a parameter associated with the entity. The insurance verification computer includes a transmitter, a receiver, and a processor in communication with each other. The receiver is configured to receive the insurance information verification request from the third party transmitter. The processor is configured to determine whether insurance information associated with the entity includes an insurance policy. When the processor determines that the insurance information associated with the entity includes the insurance policy, the processor further is configured to determine a policy status of the insurance policy; and the transmitter is configured to transmit to the third party computer, a verification message verifying that the insurance information associated with the entity includes the insurance policy. The verification message includes the policy status. When the processor determines that insurance information associated with the entity does not include the insurance policy, the transmitter is configured to transmit an alert message to the third party computer. The alert message indicates that the entity does not have insurance.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a block diagram of an exemplary insurance verification system, in accordance with the principles of the present invention;

FIG. 2 is a block diagram of an exemplary insurance information repository storing insurance information, in accordance with the principles of the present invention;

FIG. 3 is a block diagram of an exemplary insurance verification computer, in accordance with the principles of the present invention; and

FIG. 4 is a flow chart of an exemplary process for verifying insurance information, in accordance with the principles of the present invention.

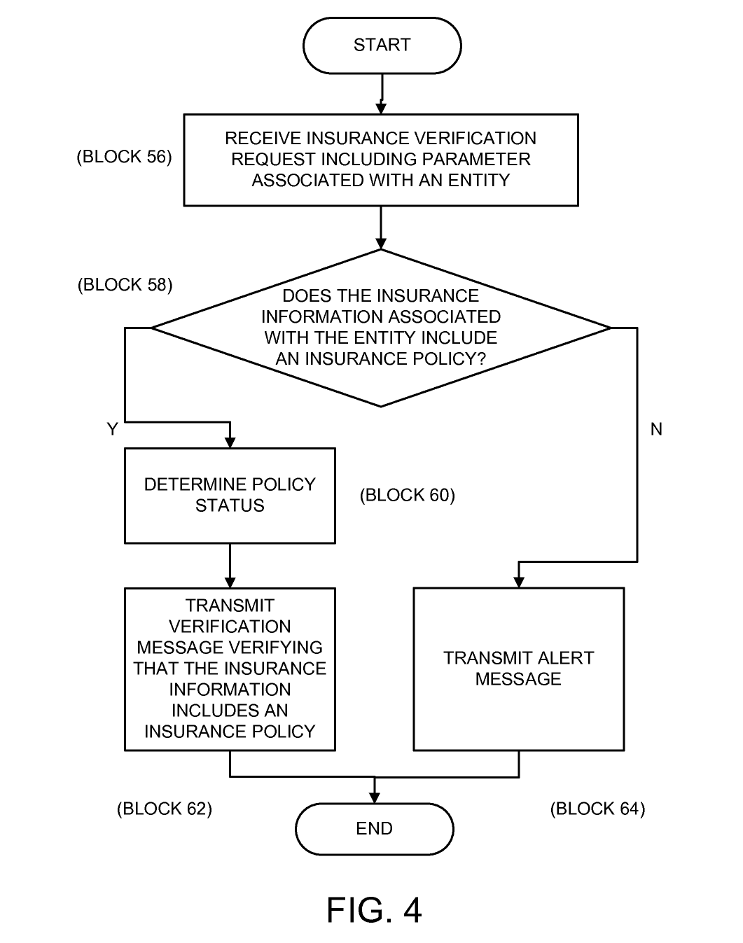

### DETAILED DESCRIPTION

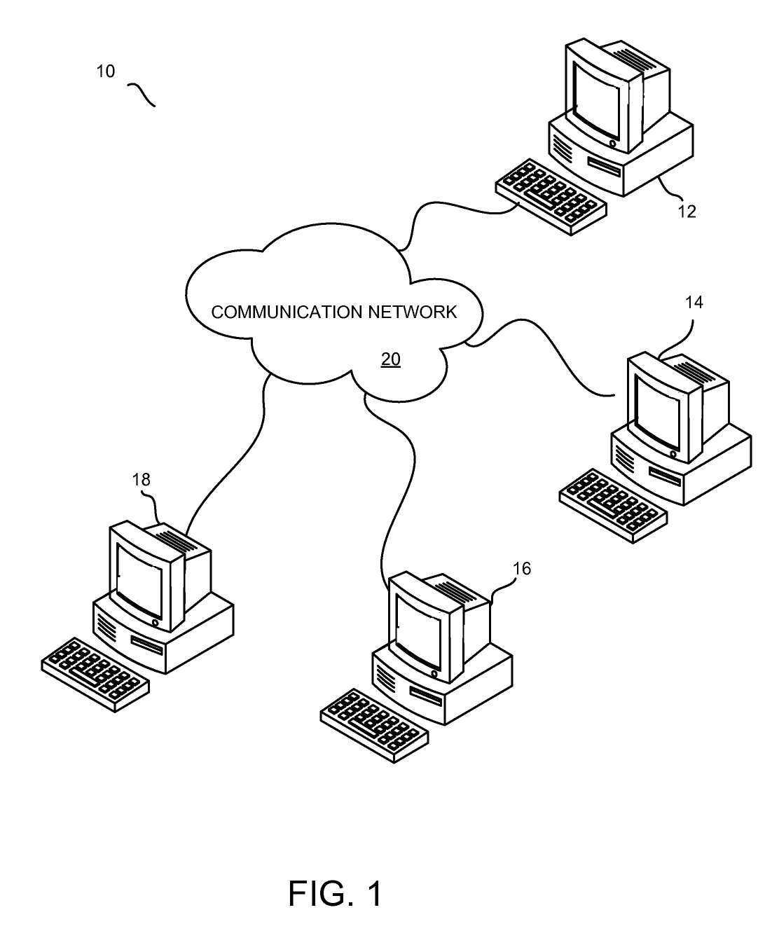

Referring now to the drawing figures in which reference designators refer to like elements, there is shown in FIG. 1 a schematic illustration of an insurance verification system in accordance with the principles of the present invention, and generally designated as “10”. Insurance verification system 10 includes insurance verification computer 12 configured to determine insurance information and transmit the determined insurance information to a third party computer. Insurance verification computer 12 may be in communication with one or more third party computers, such as government computer 14, insurance carrier computer 16 and financial institution computer 18 via communication network 20. Insurance verification computer 12 may store insurance information in insurance information repository/database 22.

Insurance verification computer 12 may be a computer server, a mainframe computer, a remote server, among other types of computing devices. Insurance verification computer 12 may receive an insurance information request message from a requester. The requester may wish to receive insurance information from insurance verification computer 12. The requester may be a third party computer, such as government computer 14, insurance carrier computer 16 and/or financial institution computer 18. The insurance information request message, i.e., the request for insurance information, may include a parameter associated with an entity. An entity may be, for example, a person or a company. The parameter associated with the entity may be a federal identification number, a name associated with an entity, a driver's license number corresponding to an entity, a tax identification number corresponding to an entity, among other identifications uniquely identifying an entity.

The insurance information verification request may include a request to verify whether the entity has insurance, i.e., whether the entity associated with the transmitted identification parameter has an active insurance policy. Insurance verification computer 12 may determine the requested insurance information, i.e., whether the entity is associated with an insurance policy, by querying insurance information repository 22. Insurance verification computer may transmit the requested insurance information to the requester via communication network 20.

Communication network 20 may include a cellular communication network and the Public Switched Telephone Network (“PSTN”), or other wide area network (“WAN”), such as the Internet, as well as local area networks (“LANs”), such as an Ethernet LAN. Communication network 20 may be an optical network, a wireless network, such as Wi-Fi, satellite, infrared, Bluetooth, Near Field Communications, or other communications network. Insurance verification computer 12, government computer 14, insurance carrier computer 16 and financial institution computer 18 may be connected via communication network 20 to other computers, such as an entity's computer and other computers associated with any other third party (not shown).

Government computer 14 may be a computer that stores government data including driving records. For example, government computer 14 may be a computer associated with a Department of Motor Vehicles. Government computer 14 may alternatively be a computer that stores police and criminal records, such as a law enforcement computer associated with a police department, the Department of Homeland Security or the Federal Bureau of Investigations. Government computer 14 may further be a computer that stores tax records, such as a computer associated with a Tax Collectors Office or the Internal Revenue Service. Insurance carrier computer 16 may be a computer associated with an insurance company, and financial institution computer 18 may be a computer associated with a financial institution, such as a bank, a credit card company, a credit report agency, a loan agency, etc.

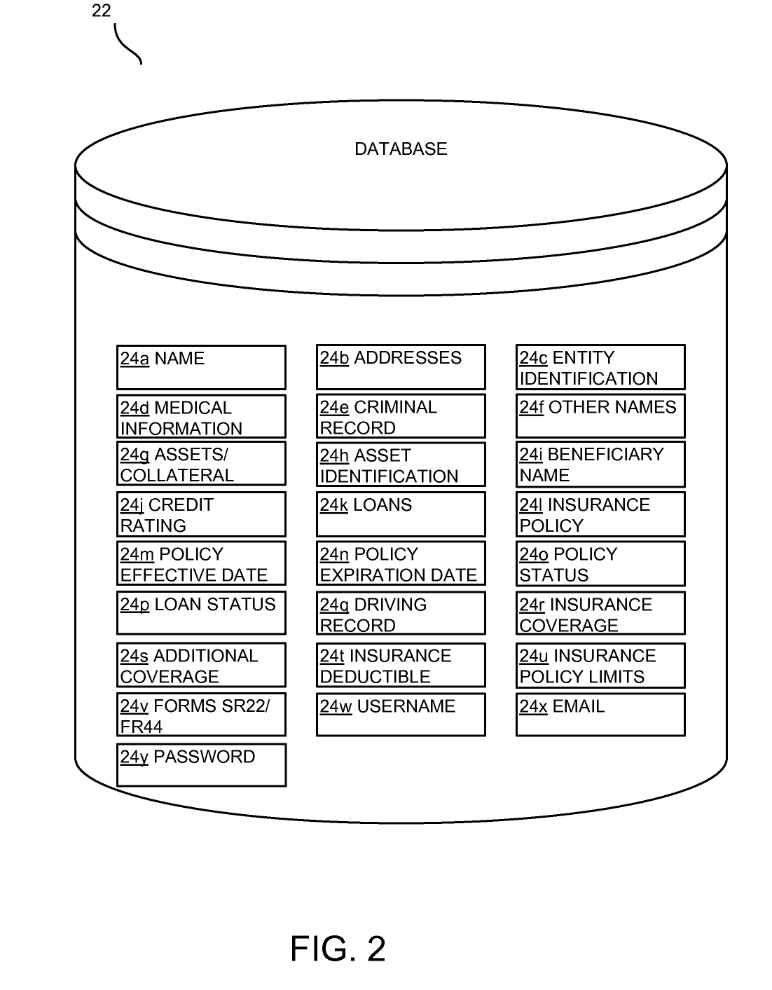

FIG. 2 is a block diagram of an exemplary insurance information repository 22. Insurance information repository 22 may be stored in a memory location of insurance verification computer 12. Insurance verification computer 12 may store insurance information associated with an entity as a comprehensive collection of related data organized for convenient access. Insurance verification computer 12 may store the insurance information in insurance information repository 22, which may be a database. Alternatively, insurance verification computer 12 may store the insurance information in any other format for organizing and relating data.

In an exemplary embodiment, insurance information repository 22 may be stored in another computer or a storage device in communication with insurance verification computer 12. Insurance information may include any information pertaining to an insurance policy. Insurance information repository 22 may associate the insurance information corresponding to an entity, with an identification, such as an entity identification number (e.g., a social security number). A search of insurance information repository 22 using a parameter that includes the entity identification will return insurance information corresponding to the entity.

Insurance information repository 22 stores insurance information associated with an entity. The insurance information may include, but may not be limited to any insurance policy information associated with an insurance policy purchased by an entity, loan information corresponding to loans associated with an entity, and documents. Documents may include a car insurance policy, a homeowners insurance policy, a motorcycle policy, a life insurance policy, a vehicle title, loan documentation, traffic tickets received by a person, supporting documentation for an insurance policy, bank account documentation, bank statements, receipts proving an amount paid for an insured asset, insurance claims, tax forms, etc.

The insurance information may further include an entity's name 24a, age, sex, date of birth, a list of addresses 24b associated with an entity (including a primary residence address and a business address), email address, and an entity identification 24c, such as a social security number, a government identification, a birth certificate information, a driver's license, passport number, etc. Insurance information may further include work related information such as an employer name, job title, salary, length of time working at employer, names of previous employers, etc. Insurance information may further include medical information 24d, information on previous existing health conditions, a medical history, health related information, such as blood type and medicines that a person is taking, health allergies, operations, hospitalizations, etc. Other insurance information may include a criminal record 24e, citizenship information, previous/other names used 24f, level of education, sources of income, military service information, tax information, number of dependants, monthly mortgage or rental payment, corporations associated with an entity, bank accounts, automobiles own or leased by an entity, etc.

Insurance information may further include, but may not be limited to a list of assets that may be used as loan collateral 24g (such as automobiles, boats, recreational vehicles, jewelry, real estate, etc.); an asset identification 24h, such as a vehicle identification number (“VIN”); a description of an insured asset; a value of an asset; a list of liabilities; a monetary value associated with each liability; a list of properties owned by an entity; a value of each property; a name of a co-owner of a property; a name of a co-borrower; a name of a beneficiary 24i of an insurance policy; financial information associated with an entity, such as a credit rating 24j associated with an entity; and a list of loans 24k corresponding to an entity, such as an automobile loan, home loan, business loan, etc., among other insurance information.

Insurance information can further include information relevant to a contract, such as a loan contract or an insurance policy contract, including but not limited to at least one insurance policy 24l (active and inactive) associated with an entity; the policy effective date 24m; an expiration date, such as policy expiration date 24n; contract term, such as insurance policy term or loan term; loan payment history; insurance premium payment history; policy status 24o, such as whether the insurance policy is active and the premiums are being paid on-time or whether the insurance policy has lapsed and is inactive; and status of a loan 24p (whether it is being paid on-time or whether the loan is in default).

Insurance information may further include government information associated with an entity, such as a driving record 24q, which may be provided by an entity or the government. Driving record 24q may include the driving history, accidents, traffic violations, tickets, traffic related convictions corresponding to an entity, government forms 24v associated with an insurance policy, such as, an SR22 form which an insurance company provides to a government branch, such as a court or a Department of Motor Vehicles, to demonstrate proof of financial responsibility for persons convicted of a traffic violation. Another form stored in insurance information repository 22 may be an FR44 form used to demonstrate proof of financial responsibility for a person who was convicted of driving under the influence. The SR22 form and the FR44 form verify that a person has purchased insurance.

Other insurance information may include, but not be limited to, insurance policy history, such as a prior insurance policy and a type of insurance policy that a person had purchased in the past; a length of time the prior insurance policy was active; a list and description of insurance policies associated with an entity, including insurance policies that are currently active or inactive/expired; insurance coverage 24r for each insurance policy associated with an entity; actual cash value of an asset covered by an insurance policy; information on additional equipment coverage 24s which covers other equipment added to an insured asset, such as especial rims on a car; a minimum liability coverage amount; a description of any previous damage for an insured asset; depreciation percentages per year for an insured asset; insurance deductible information 24t; gap coverage protection information, i.e., optional coverage that applies to increase an amount of recovery in the event of a total loss of an asset subject to a loan or lease agreement, where the amount of outstanding indebtedness is greater than the actual cash value; information on payment protection, which may cover insurance premiums if a person becomes disabled; an insurance rate; a loan interest rate; information on whether the policy is a paid in full policy; optional insurance coverage, such as rental reimbursement coverage to cover the costs of renting a car, or pleasure rental coverage to cover the cost of replacing a rental car that has been stolen; insurance policy cost; insurance policy limits 24u, which includes information on the monetary limits of an insurance policy; insurance premium amount; prior loans associated with an entity; contract renewal options, such as an insurance renewal options; renewal date; return premium; a stated amount value, which is the value an asset is insured for after an appraisal of the asset has been conducted; a contract type, such as a loan type or an insurance policy type, i.e., whether an insurance policy is a home owners insurance policy, automobile insurance policy, life insurance policy or a business and commercial insurance policy, etc.; a written period amount by an insurance company, which may include new business, renewals, and policy endorsements; mechanical breakdown coverage; policy coverage limits; insurance coverage exclusions; settlements paid to an entity; aggregate limit, which indicates an amount of coverage for a period of time; living and death benefits; and endorsement benefits for other assets not covered in an original insurance policy, among other insurance information.

Insurance information may further include insurance information associated with a real estate asset, including but not limited to home insurance information; sinkhole coverage data; catastrophic ground coverage information; collapse coverage information; inspection data; conditions of an asset or an asset's parts including doors, windows, electrical system, plumbing, heating and air-conditioning, roof shape, wall construction, building structure and composition, etc.

Insurance information may further include a username 24w, email address 24x and password 24y of an entity associated with the insurance information. An entity may access the insurance information using their username 24w and password 24y. An entity may make changes to the insurance information corresponding to the entity, such as adding new information, deleting old information, modifying incorrect information, etc. The insurance information may be configured to ensure that only certain insurance information may be modified. For example, an entity may be able to change their telephone number or the name of an insurance policy beneficiary 24i, but may not be able to delete their criminal record 24e or medical information 24d. In another embodiment, the entity would not be able to make any changes and would only be able to submit a request to make changes.

Insurance information may further include a measure of exposure and vulnerability to loss associated with an entity or an asset, where death of a person, dissolution of a corporation or destruction of the asset may cause financial loss. Insurance information may also include a risk profile that analyzes a history of casualties, i.e., liabilities or loss resulting from accidents associated with an entity. A risk profile may establish trends which may be considered by an insurance company in determining whether to issue an insurance policy to an entity. For example, a risk profile may alert an insurance company that an entity has recovered insurance proceeds for two or more houses that were destroyed in fires. Risk profiles may be categorized as standard, non-standard and preferred.

A risk profile may differentiate between different types of losses. For example, a first type of losses experienced by an entity may be different from a second type of losses, such as accident losses, in that first type losses do not have to be sudden and fortuitous like second type losses, but may result from repeated exposure that results in bodily injury or property damage which is not expected or intended. A risk profile may also include civil lawsuits or criminal actions that an entity has been a party to, which may help indicate how litigious an entity is.

Insurance information repository 22 may further include a description of a type of insurance policy associated with an entity. For example, an insurance policy may be an automobile liability insurance policy that provides coverage for bodily injury and property damage caused by an automobile associated with an entity. Other types of insurance policies include an automobile collision insurance policy, a comprehensive insurance policy a general liability insurance policy and a non-standard insurance policy, among others. An automobile collision insurance policy covers physical damage to an automobile. Comprehensive insurance provides protection in case of theft or damage to an automobile. General liability insurance protects from liabilities arising from accidents in premises, resulting from operations, sold products, contractual liability, negligence, etc. Non-standard insurance may include insurance provided to a high risk person, such as a person that has been refused insurance coverage.

In another exemplary embodiment, insurance information repository 22 may also include one or more lists of users who are authorized to access the insurance information associated with an entity. Insurance information repository 22 may also include the extent to which insurance information may be accessed by users. For example, users on an authorized user list may have access to all or part of the insurance information, while users that are not on an authorized user list may be able to access limited insurance information, such as an entity's primary address or information that determines whether an entity does or does not have an active insurance policy. In an exemplary embodiment, only a registered user would be able to access any but limited information. Of note, the invention is not limited to the above examples. Other types of insurance information may be included in insurance information repository 22.

In another exemplary embodiment, insurance information may be categorized according to different security levels, such as first level insurance information, second level insurance information and third level insurance information. Users on an authorized user list may be authorized to access one or more of the first, second and third level insurance information. Third level insurance information may include more sensitive insurance information than third level insurance information. By way of example, first level insurance information may include an email address, while third level insurance information may include an income associated with an entity, such as a person's salary.

In another exemplary embodiment, insurance information may also be categorized by type or class. The different types include, but may not be limited to, insurance information associated with an asset, insurance information associated with an entity, insurance information associated with financials of an entity, insurance information associated with contact information, insurance information associated with a driving record of an entity, and insurance information associated with a medical history of an entity, among other classifications. An authorized user list may indicate which category of insurance information may be accessed by which users. By way of example, the authorized user list may indicate that insurance information classified as insurance information associated with financials may be accessible by a first group of users, while insurance information categorized as insurance information associated with contact information, like a primary residence address, may be accessible by a second group of users.

Of note, although insurance information is described herein as being stored in a “database” or a “repository,” the invention is not limited to storage in a formal database management system, e.g., SQL, Access, etc. or a formal repository. It is contemplated that any memory storage device can store the insurance information in an organized and retrievable form, such as using a flat file, a hash structure, etc. Further, insurance information is not limited to information discussed above, and may include any other information.

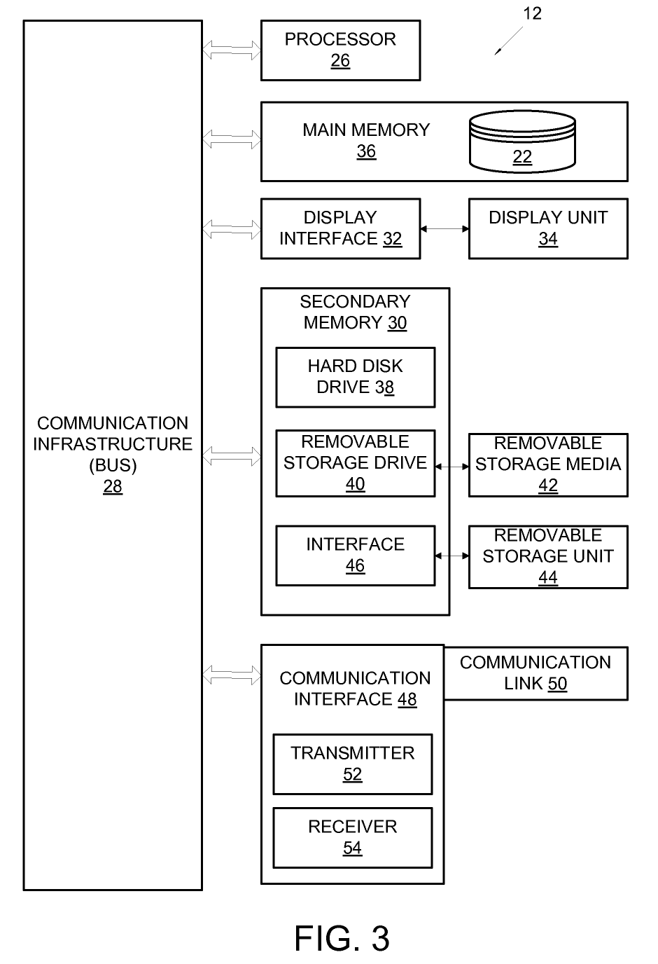

FIG. 3 is a block diagram of an exemplary insurance verification computer 12 constructed in accordance with the principles of the present invention. Insurance verification computer 12 includes one or more processors, such as processor 26 programmed to perform the functions described herein. Processor 26 is operatively coupled to a communication infrastructure 28, e.g., a communications bus, cross-bar interconnect, network, etc. Processor 26 may execute computer programs stored on disk storage for execution via secondary memory 30.

Various software embodiments are described in terms of this exemplary computer system. It is understood that computer systems and/or computer architectures other than those specifically described herein can be used to implement the invention. It is also understood that the capacities and quantities of the components of the architecture described below may vary depending on the device, the quantity of devices to be supported, as well as the intended interaction with the device. For example, configuration and management of insurance verification computer 12 may be designed to occur remotely by web browser. In such case, the inclusion of a display interface and display unit may not be required.

Insurance verification computer 12 may optionally include or share a display interface 32 that forwards graphics, text, and other data from the communication infrastructure 28 (or from a frame buffer not shown) for display on the display unit 34. Display 34 may be a cathode ray tube (CRT) display, liquid crystal display (LCD), light-emitting diode (LED) display, and touch screen display, among other types of displays. The computer system also includes a main memory 56, such as random access memory (“RAM”) and read only memory (“ROM”), and may also include secondary memory 30. Main memory 36 may store insurance information repository 22.

Secondary memory 30 may include, for example, a hard disk drive 38 and/or a removable storage drive 40, representing a removable hard disk drive, magnetic tape drive, an optical disk drive, a memory stick, etc. The removable storage drive 40 reads from and/or writes to a removable storage media 42 in a manner well known to those having ordinary skill in the art. Removable storage media 42, represents, for example, a floppy disk, external hard disk, magnetic tape, optical disk, etc. which is read by and written to by removable storage drive 40. As will be appreciated, the removable storage media 42 includes a computer usable storage medium having stored therein computer software and/or data.

In alternative embodiments, secondary memory 30 may include other similar devices for allowing computer programs or other instructions to be loaded into the computer system and for storing data. Such devices may include, for example, a removable storage unit 44 and an interface 46. Examples of such may include a program cartridge and cartridge interface (such as that found in video game devices), flash memory, a removable memory chip (such as an EPROM, EEPROM or PROM) and associated socket, and other removable storage units 44 and interfaces 46 which allow software and data to be transferred from the removable storage unit 44 to other devices.

Insurance verification computer 12 may also include a communications interface 48. Communications interface 48 allows software and data to be transferred to external devices. Examples of communications interface 48 may include a modem, a network interface (such as an Ethernet card), a communications port, a PCMCIA slot and card, wireless transceiver/antenna, etc. Software and data transferred via communications interface/module 48 may be, for example, electronic, electromagnetic, optical, or other signals capable of being received by communications interface 48. These signals are provided to communications interface 48 via the communications link (i.e., channel) 50. Channel 50 carries signals and may be implemented using wire or cable, fiber optics, a phone line, a cellular phone link, an RF link, and/or other communications channels.

It is understood that insurance verification computer 12 may have more than one set of communication interface 48 and communication link 50. For example, insurance verification computer 12 may have a communication interface 48/communication link 50 pair to establish a communication zone for wireless communication, a second communication interface 48/communication link 50 pair for low speed, e.g., WLAN, wireless communication, another communication interface 48/communication link 50 pair for communication with low speed wireless networks, and still another communication interface 48/communication link 50 pair for other communication. Communication interface 48 may include transmitter 52 and receiver 54.

Computer programs (also called computer control logic) are stored in main memory 36 and/or secondary memory 30. For example, computer programs are stored on disk storage, i.e. secondary memory 30, for execution by processor 26 via RAM, i.e. main memory 36. Computer programs may also be received via communications interface 48. Such computer programs, when executed, enable the method and system to perform the features of the present invention as discussed herein. In particular, the computer programs, when executed, enable processor 26 to perform the features of the corresponding method and system. Accordingly, such computer programs represent controllers of the corresponding device.

In an exemplary embodiment, an entity may create an account in insurance verification computer 12 in order to store and access insurance information and documents stored in insurance information repository 22 in main memory 36. Processor 26 may create an account and an account identifier. The account identifier may include an account number, a social security number, a tax identification number, or any other identification that uniquely identifies an entity. Processor 26 may further create a username 24w and password 24y that the entity may use to log into insurance verification computer 12. Username 24w may be a username selected by the entity. The account identifier, username 24w and password 24y correspond to insurance information associated with the entity. The insurance information may include insurance policy 24l.

In an exemplary embodiment, the entity may want to access the insurance information associated with their account identifier. For example, the entity may wish to access insurance policy 24l associated with the entity. Insurance policy 24l may be stored in insurance information repository 22 and may include insurance policy data. Insurance verification computer 12 may receive an insurance information access request from the entity. The insurance information access request may include the account identifier and the password. Insurance verification computer 12 may provide access to the insurance information to the entity.

In another exemplary embodiment, an entity may upload documents and enter insurance information associated with the entity into insurance verification computer 12 using a personal computer, such as a mobile telephone. The insurance information entered and the uploaded documents are associated with an account identifier corresponding to the entity. The insurance information entered is stored in insurance information repository 22. An entity may access the stored documents and insurance information by login into their account from any computer, mobile telephone, personal digital assistant, wireless mobile device, tablet computer, personal computer, etc. connected to communication network 20. Documents may be accessible from any place in the world with an Internet connection. Insurance verification computer 12 may be part of a cloud computing environment where important documents, insurance information and loan information are stored in the cloud for easy retrieval.

The insurance policy, insurance information and supporting documentation may be stored in insurance information repository 22 in insurance verification computer 12 for future retrieval. The insurance information, loan information and documents may be stored in insurance information repository 22 in memory 36 of insurance verification computer 12 for an indefinite time or for a determined amount of time. For example, insurance information repository 22 may be configured to retain the documents and insurance information for a period of five years.

In another exemplary embodiment, an insurance company may send to insurance verification computer 12 insurance information for storage in insurance information repository 22. An entity may purchase an insurance policy from an insurance company associated with a third party computer, such as insurance carrier computer 16. The third party computer, e.g., insurance carrier computer 16, may receive insurance information from the entity. The insurance information may include a name 24a of an entity, an address 24b, an entity identification 24c, and supporting documentation for the insurance policy, among other insurance information. Supporting documentation may include, for example, an official vehicle title that verifies ownership of a vehicle. The third party computer, e.g., insurance carrier computer 16, may upload the insurance information associated with the entity, including an insurance policy 24l purchased by the entity.

A third party transmitter in the third party computer, e.g., insurance carrier computer 16, may be configured to send insurance information to insurance verification computer 12. Communication interface 48 may include receiver 54 configured to receive, from the third party computer, the insurance information and a parameter, e.g. an entity identification, associated with the entity whose insurance information is being received. Processor 26 may associate the insurance information with the parameter. Memory 36 may be configured to store both the insurance information and the parameter in insurance information repository 22 for future retrieval.

For example, the third party computer may want insurance information associated with an entity. Receiver 54 in insurance verification computer 12 may be configured to receive an insurance information request message from the third party computer. The insurance information request message includes a parameter associated with an entity. Processor 26 in insurance verification computer 12 may further be configured to determine insurance information associated with the parameter at least in part by searching the insurance information repository 22 using the parameter. Processor 26 may retrieve from the insurance information repository 22 all or part of the insurance information associated with the parameter, i.e., with the entity. Transmitter 50 in insurance verification computer 12 may transmit the insurance information associated with the parameter to the third party computer.

In another exemplary embodiment, when insurance verification computer 12 receives insurance information (including a parameter associated with an entity) for storage in insurance information repository 22, processor 26 in insurance verification computer 12 may determine whether insurance verification computer 12 stores an account associated with the parameter, e.g., an entity identification, account identifier, username, etc. If processor 26 determines that there is an account already created, insurance verification computer 12 stores the insurance information and documents in the account corresponding to the received parameter.

Otherwise, if processor 26 determines that there is not an account associated with the parameter, processor 26 creates an account and an account identifier. Processor 26 proceeds to associate the account identifier with the received insurance information and the parameter. Insurance verification computer 12 stores the insurance information and documents received from the third party computer in the newly created account. Further, processor 26 may create a temporary username and password for the account. Insurance verification computer 12 may send a message including the temporary username and password to the entity associated with the new account via email. The message may contain instructions as to how to create a new username and password to login into insurance verification computer 12.

An entity may receive the email including the login instructions, and may create a new username and password to associate with their account. Alternatively, an entity may decide not to create a new username and password, and may use the temporary username and password instead to log into their account. An entity may decide not to use their account to store insurance information and documents. Even so, the account will still remain active and will be accessible by requesters, such as government computer 14, insurance carrier computer 16 and financial institution computer 18, who may search and access the insurance information associated with the account. The insurance information in insurance verification computer 12 may be made available to the entity after the entity purchases the insurance policy.

In another exemplary embodiment, regardless as to whether an entity may or may not wish to receive or access documents via insurance verification computer 12, a third party may create an account for the entity. The third party may use an entity's email address to create the entity account. Insurance verification computer 12 may send a message to the entity via, for example, email, explaining that, in order to minimize an insurance company's risk of potential economic loss or the loss of collateral in a loan application, an account for the entity has been created to store insurance information associated with the entity. The message may further explain that a third party such as the government via government computer 14, an insurance carrier via insurance carrier computer 16 and/or a financial institution via financial institution 18, may upload a document or enter insurance information associated with the entity into the entity's account for storage in insurance information repository 22.

In another exemplary embodiment, an insurance company may receive from an entity a request to purchase an insurance policy. For instance, the entity may wish to change insurance carriers. The insurance company may request from the entity a parameter associated with the entity, such as entity identification 24c, name 24a or an account identifier. Insurance carrier computer 16 may send to insurance verification computer 12 an insurance information verification request including the parameter. Insurance verification computer 12 may determine whether insurance verification computer 12 stores an account associated with the parameter and whether the account includes insurance information.

Receiver 54 in insurance verification computer 12 may receive the insurance information verification request from the third party computer, e.g., insurance carrier computer 16. The insurance information request may include the parameter associated with an entity. Processor 26 may query insurance information repository 22 using the received parameter to determine whether insurance information repository 22 includes insurance information corresponding to the parameter. Memory 36 in insurance verification computer 12 may be configured to store the insurance information repository 22 which includes the insurance information. Processor 26 may be configured to determine whether the insurance information associated with the entity includes an insurance policy. When processor 26 determines that insurance information associated with the entity and stored in insurance information repository 22 includes an insurance policy, the processor resolves that the entity has insurance. Processor 26 may determine a policy status of the insurance policy 24l. The status 24o of the insurance policy may be one of active or inactive (cancelled, lapsed, etc.).

If the entity has insurance, i.e., the processor determines that insurance information associated with the entity includes insurance policy 24l, transmitter 52 in insurance verification computer 12 may send to the third party computer, e.g., insurance carrier computer 16, a verification message verifying that insurance information associated with the entity or parameter includes an insurance policy. Transmitter 52 may also transmit the policy status 24o. Insurance verification computer 12 may further send to the requester any insurance information associated with the entity. Otherwise, if the entity does not have insurance, i.e., the processor determines that insurance information associated with the entity does not include an insurance policy, transmitter 52 in insurance verification computer 12 may send to the third party computer, e.g., insurance carrier computer 16, an alert message indicating that the entity does not have insurance. The alert message may state that no insurance information was found for the parameter provided in insurance information repository 22.

In another exemplary embodiment, insurance carrier computer 16 may send to insurance verification computer 12 an insurance policy application form corresponding to an insurance policy an entity wishes to purchase. The insurance policy application form may include blank spaces which can be filled out with insurance information. Insurance verification computer 12 may use the insurance information and supporting documentation associated with the parameter, e.g., the entity identification, to automatically fill out the blank spaces in the insurance policy application form. In another embodiment, the system would not be able to prefill blank spaces. Alternatively, insurance verification computer 12 may send insurance information associated with the parameter to insurance carrier computer 16, so insurance carrier computer 16 can use the insurance information to automatically fill out the insurance policy application form. The insurance information received by insurance carrier computer 16 from insurance verification computer 12 may be used to automatically populate an insurance policy application form.

By retrieving the insurance information from insurance verification computer 12 and using the information to fill out an insurance policy application, the chances of entering erroneous information in the insurance policy application form may decrease. Storing information in insurance information repository 22 preserves the integrity of the information used to underwrite an insurance policy, as the possibility of obtaining erroneous or false information is reduced. For example, typing errors caused by having an agent of the insurance company enter insurance information manually into insurance carrier computer 16 may be reduced or eliminated.

An insurance company may use the insurance information in insurance information repository 22 for preparing an insurance policy for a person. Insurance information, loan information and documents in insurance information repository 22 may be retrieved by a requester, such as insurance carrier computer 16, to assist in underwriting an insurance policy and/or claim processing. For example, insurance carrier computer 16 may receive insurance information stored in insurance information repository 22, such as the name 24a, address 24b, etc. of an entity from insurance verification computer 12. An agent of the insurance company may use the insurance information to fill out and write an insurance policy. Using the insurance information in the insurance information repository 22 may save the insurance company time in preparing the insurance policy, as a large percentage of the information needed by the insurance company to write the insurance policy may already be stored in insurance information repository 22.

In another exemplary embodiment, insurance verification computer 12 acts as a central repository of information obtained from different sources, including but not limited to, government computer 14, insurance carrier computer 16 and financial institution computer 18. The insurance information stored in insurance information repository 22 may be entered and retrieved by an entity who is applying for insurance, as well as a third party who wants to know insurance information associated with an entity. A third party, such as the government, an insurance company and a financial institution may enter insurance information into insurance verification computer 12 via government computer 14, insurance carrier computer 16 and financial institution computer 18 respectively. For example, an insurance company agent may enter insurance information using insurance carrier computer 16. The insurance information may include data on an entity who purchased an insurance policy from the insurance carrier. Further, any other party may store and retrieve information and documents from insurance verification computer 12 using computers (not shown) connected to communication network 20.

In another exemplary embodiment, creation of an account in insurance verification computer 12 may be free or may be associated with a cost. An entity may create an account in order to access or store insurance information in insurance information repository 22. An entity may pay for creation of the account. Alternatively, the cost may be subsidized by parties wanting to have access to the insurance information stored in insurance information repository 22. For example, the cost of maintaining accounts in insurance verification computer 12 may be subsidized by insurance companies, financial institutions and/or the government. An entity may be offered an incentive, such as a discount on an insurance premium, if the entity opens an account in insurance verification computer 12 and includes insurance information associated with the entity.

In another exemplary embodiment, an entity whose insurance information is stored in insurance information repository 22, may wish to give a third party access to the insurance information. For example, an entity wanting to purchase an insurance policy from an insurance company may allow the insurance company to access the insurance information corresponding to the entity. To that end, the entity may give an insurance company a parameter, such as an entity identification, an account identification, social security number, etc., associated with their insurance information. The insurance company may have access to this information by inputting the entity's name, address and/or driver's license number. In an exemplary embodiment, the insurance company would only receive information if the insurance verification system has any documentation for the entity. The insurance company may access the insurance information using the parameter. Insurance carrier computer 16 may download the insurance information from insurance verification computer 12.

In another exemplary embodiment, an insurance company may determine whether to issue an insurance policy to an entity based at least in part on an analysis of documents and insurance information stored in insurance information repository 22. A requester, such as a third party computer, may send to insurance verification computer 12 a request to perform an analysis of insurance information associated with an entity. The requester may send a parameter, such as an entity identification, social security, insurance policy number, username 24w, etc., associated with the entity to insurance verification computer 12. Processor 26 in insurance verification computer 12 may employ metrics to analyze the insurance information associated with the parameter. Processor 26 may also use a prediction algorithm to predict the likelihood that an entity associated with the parameter will become involved in an activity that will trigger a claim, such as an accident. Insurance verification computer 12 may send to insurance carrier computer 16 an analysis of the insurance information associated with the entity, so that the insurance company may determine whether or not to insure the entity based at least in part on the analysis.

In another exemplary embodiment, an insurance company may access insurance policies stored in insurance information repository 22 which were previously issued to an entity by the insurance company or by other insurance companies. Insurance carrier computer 16 may send to insurance verification computer 12 a parameter identifying an entity. Insurance carrier computer 16 may request that insurance verification computer 12 send to insurance carrier computer 16 insurance information including previously issued insurance policies associated with the parameter, e.g., with a person. Receiver 54 in insurance verification computer 12 may be configured to receive an insurance information request message from a third party transmitter in third party computer, the insurance information request message including the parameter associated with the entity. The insurance information request message may also include a request for insurance information corresponding to a prior insurance policy associated with the entity. Processor 26 in insurance verification computer 12 may be further configured to determine insurance information corresponding to the prior insurance policy associated with the entity. Processor 26 may also determine a length of time the prior insurance policy was active. Transmitter 52 in insurance verification computer 12 may be further configured to transmit the insurance information corresponding to the prior insurance policy associated with the entity, and the length of time the prior insurance policy was active to the third party computer. Insurance carrier computer 16 may determine whether to issue an insurance policy to the entity based at least in part on whether the entity had prior insurance coverage.

Insurance carrier computer 16 may compare the insurance information in previous insurance policies with current insurance information received from the entity to determine inconsistencies. Alternatively, insurance carrier computer 16 may request insurance verification computer 12 to compare the insurance information in previous insurance policies issued to an entity with the current insurance information supplied by the entity. The current insurance information may be transmitted by insurance carrier computer 16 to insurance verification computer 12. Insurance verification computer 12 may determine, based on the comparison, a probability that the current information supplied is fraudulent.

Insurance verification computer 12 may alert the insurance company of any discrepancies between the insurance information in the previously issued insurance policies and the current insurance information. For example, a previously issued car insurance policy may indicate that a person has been involved in three car accidents over their lifetime. However, the current insurance information that the person provided to the insurance company may instead indicate that the person has been involved in only one car accident. The discrepancy may be a typo made by an insurance company agent in entering the current insurance information into insurance carrier computer 16 for transmission to insurance verification computer 12 or may result from the person providing false information to the insurance company.

In another exemplary embodiment, financial institution computer 18 associated with a financial institution such as a lender company that offers loans, may receive insurance information from insurance verification computer 12. A financial institution may wish to confirm that an asset designated as collateral is insured so that, if a borrower defaults on a loan, the financial institution may recover the amount loaned, regardless of whether the collateral has been damaged, destroyed or stolen. Insuring an asset assigned as collateral may assure a lender that a claim can be filed with an insurance company to recover the value of the collateral in the case that the collateral is damaged, destroyed or stolen, i.e., the collateral cannot be sold. Insurance verification computer 12 may determine whether an asset is insured. Further, insurance verification computer 12 may determine whether an entity has illegally purchased double insurance coverage for an asset (“double dip”) in order to collect from two insurance companies.

Financial institution computer 18 may send to insurance verification computer 12 a parameter. The parameter may uniquely identify a person, an insurance policy, a collateral asset, etc. Insurance verification computer 12 may send to financial institution computer 18 insurance information associated with the parameter, such as insurance information on an asset designated as collateral in a contract for a loan. Insurance verification computer 12 may query insurance information repository 22 using the parameter received to determine whether an asset designated as collateral, such as a vehicle, boat, motorcycle, etc., is insured. Insurance verification computer 12 may send to financial institution computer 18 proof of insurance information associated with the parameter, e.g., an asset, such as insurance policy 24l.

In another exemplary embodiment, insurance verification computer 12 may be configured to periodically query insurance information repository 22 using a parameter associated with an asset to determine whether the asset, which was designated as collateral in a loan contract, is still insured. Processor 26 may determine whether an insurance policy is scheduled to become inactive prior to a predetermined date at least by retrieving from insurance information repository 22 a policy expiration date 24n corresponding to the insurance policy. Processor 26 may compare the policy expiration date 24n with the predetermined date.

Transmitter 52 in insurance verification computer 12 may transmit to a third party computer, e.g., financial institution computer 18, a warning message if the insurance policy is scheduled to become inactive before the predetermined date, the warning message including a policy expiration date 24n associated with an insurance policy covering the asset. Additionally, transmitter 52 may send policy status 24o to the third party computer. The policy status 24o may indicate that an insurance policy is active or inactive. Further, insurance verification computer 12 may determine that an insurance is about to expire.

Insurance verification computer 12 may send to the financial institution computer 18 a notification including the policy expiration date 24n. A real time notification may allow the financial institution to receive the insurance information faster than if the notification was mailed by the insurance company. The financial institution, upon receipt of a notification stating that a policy has expired, usually requests information from the borrower. By the time the borrower replies back to the financial institution, the collateral may have been uninsured for a period of 60 to 90 days. If during that time the borrower would have defaulted and the collateral would have been damaged, the financial institution would not have been able to recover payment for the loan.

Insurance verification computer 12 may periodically transmit changes, such as a change in insurance policy limits 24u, for an insurance policy associated with an asset to financial institution computer 18. Insurance verification computer 12 may send status updates to financial institution computer for a predetermined term, which may be the term of a loan. Insurance verification computer 12 may further transmit to financial institution computer 18 insurance information, such as a criminal record 24e, corresponding to a person who has applied for a loan at the financial institution. By way of example, receiver 54 in insurance verification computer 12 may be configured to receive from a third party computer an insurance information request message including a parameter associated with an entity or an insurance policy. The insurance information request message may include a request to alert the third party computer when a change to insurance policy 24l associated with the entity has occurred.

In another exemplary embodiment, insurance verification computer 12 may analyze insurance information to create a risk profile for an entity. Insurance information may include, for example, a number of claims filed by an entity, frequency of claims filed by an entity, or an amount of money received from an insurance company due to a claim filed, among other criteria. Insurance verification computer 12 may compare the number of claims filed by an entity against a predetermined number of claims and, if the number of claims filed by an entity is less than the predetermined number, the entity may be considered a low risk policy holder. Otherwise, if the number of claims filed by the entity is at least equal to or higher than the predetermined number, the entity may be considered a high risk policy holder. The risk profile of the entity may be constantly updated by processor 26 to reflect new insurance information entered into insurance information repository 22 by a third party computer.

Insurance verification computer 12 may also compare a zip code associated with an address of an entity to predetermined zip codes corresponding to high risk cities, such as cities where there is a high incident of stolen vehicles. If the zip code is equal to one of the predetermined zip codes, then the entity is considered a high risk policy holder. Insurance verification computer 12 may alert at least one of government computer 14, insurance carrier computer 16 and financial institution computer 18 when a risk profile of an entity indicates that the entity is a high risk policy holder. Insurance verification computer 12 may categorize a risk profile as a high risk profile, low risk profile, a standard risk profile, a non-standard risk profile or a preferred risk profile. Insurance verification computer 12 may use any other criteria that will help determine a risk profile for a person.

In another exemplary embodiment, insurance verification computer 12 may study insurance information to determine trends associated with a policy holder. For example, insurance verification computer 12 may analyze insurance information to determine a history of losses associated with an entity. Insurance verification computer 12 may send an alert to at least one of government computer 14, insurance carrier computer 16 and financial institution computer 18 when a policy holder/entity files an insurance claim requesting to be compensated for a loss.

In another exemplary embodiment, a government agency, such as the Department of Motor Vehicles (“DMV”), may access insurance information stored in insurance verification computer 12 via government computer 14. Government computer 14 may query insurance information repository 22 using a parameter that identifies or is associated with an entity or an insurance policy, to determine whether an entity is insured, i.e., whether an entity is in compliance with the financial responsibility required to obtain or retain a driver license. Alternatively, government computer 14 may send to insurance verification computer 12 a request for insurance information associated with a parameter, where the parameter may include an identification corresponding to an entity. The request for insurance information may request verification of purchase of an insurance policy. Insurance verification computer 12 may determine whether an entity has purchased automobile insurance by querying insurance information repository 22 for insurance information. Insurance verification computer 12 may query insurance information using the parameter identifying the entity.

Insurance verification computer 12 may retrieve from insurance information repository 22 insurance policy information 24l. Insurance verification computer 12 may send to government computer 14 a message indicating whether a person has purchased an insurance policy along with insurance policy 24l, which may include data on an insurance policy associated with the parameter. Insurance verification computer 12 may also send to government computer 14 form 24v. Form 24v may be form SR22, indicating that a person has insurance and therefore has complied with the requirement of financial responsibility required by the DMV.

Insurance verification computer 12 may be configured to periodically send to government computer 14 information as to whether an insurance policy associated with an entity is still active. Insurance verification computer 12 may transmit proof of insurance information to government computer 14 periodically for a predetermined amount of time. For example, proof of insurance information may be sent to government computer 14 on a monthly basis for a predetermined amount of time, such as three years.

In another exemplary embodiment, when insurance verification computer 12 determines that an insurance policy is inactive, e.g., is expired, lapsed or canceled, insurance verification computer 12 may send an alert to government computer 14, so that government computer 14 may process a suspension notice. Government computer 14 may be a computer associated with the DMV or a Tax Collector. Insurance verification computer 12 may create a report identifying entities that are associated with an insurance policy that has lapsed, i.e. the insurance is inactive. Insurance verification computer 12 may automatically compile a daily report and send it to government computer 14.

Government computer 14 may suspend the driving privileges of the entities identified by insurance verification computer 12. Government computer 14 may process suspension notices indicating the suspension of the vehicle registration for vehicles owned or driven by the entities, i.e., vehicles associated with the identified entities. Government computer 14 or insurance verification computer 12 may notify the entities that their driving privileges and their vehicle registration have been suspended by issuing a suspension of driving privileges notice. Alternatively, government computer 14 may send a request including a parameter, which may be a person's identification or an insurance policy number, to insurance verification computer 12. Government computer 14 may request insurance verification computer 12 to determine whether an insurance policy associated with the parameter has become inactive.

Currently, it may take the government about 60 to 90 days from the day the insurance policy becomes inactive to issue a notice suspension of driving privileges. Having insurance verification computer 12 automatically send an alert to government computer 14 when an insurance policy becomes inactive may expedite government processing of suspension notices. The system may notify the local government, financial institution, and entity via a free account with the insurance verification system as soon as a policy has been issued an intent to cancel. The time it takes the government to learn about the inactive insurance policy may be reduced, given that the government does not need to wait for the insurance company to prepare and mail the updates. Receiving updates on inactive insurances directly from insurance verification computer 12 is faster than receiving updates from the insurance company via postal mail. As a result, the time it takes the government to learn about an inactive insurance policy and prepare a corresponding suspension notice is reduced. The government may then mail the suspension notices to an entity whose insurance has become inactive. The time it takes an entity to receive a notice of suspension may also be reduced.

Insurance verification computer 12 notifies government computer 14 of the cancellation of the insurance policy in real time. As such, the issuances of suspension notices may increase, which gives the DMV and the Tax Collector office the ability to charge additional and higher fees more often, such as fees for reinstatement of driving privileges, renewed tags and renewed registrations. Further, having insurance verification computer 12 alert government computer 14 when insurance policies become inactive may make the government aware of the inactive insurance policy faster than if the government had to wait days (60 to 90 days) to receive the notice of cancellation in the mail.

Currently, an entity may buy an insurance policy for the sole purpose of presenting the proof of insurance to the Tax Collector Office to purchase a title, tag and vehicle registration. The title, tag and vehicle registration purchased may be valid for a long period of time, such as a two year period. Once the entity receives the title, tag and vehicle registration, the entity proceeds to cancel the insurance policy. The entity then illegally uses the title, tag and vehicle registration for the period of two years. Having insurance verification computer 12 send updates regarding inactive insurance policies on real time to the Tax Collector Office may prevent the above situation, given that the Tax Collector Office will process a suspension notice once insurance verification computer 12 sends the update on an inactive insurance policy to government computer 14.

Insurance verification computer 12 may also send an alert to each entity associated with an inactive insurance policy to inform them of the cancellation or expiration of their insurance policy. Insurance verification computer 12 may send the policy expiration date 24n via email or text message. Additionally, insurance verification computer 12 may send to each entity a warning message stating that the government has been informed of the inactive status of the insurance policy and, as a result, their driving privileges may be revoked.

In another exemplary embodiment, an entity may present proof of insurance at the Tax Collector Office in order to obtain a new or renew a title of a vehicle, tag and/or a vehicle registration. Insurance verification computer 12 may give a Tax Collector Office the ability to confirm whether the insurance presented by the entity is legitimate (at present, the Tax Collector Office does not have a system capable of confirming whether the insurance is legitimate and/or meets the state minimum requirements). Government computer 14 may send to insurance verification computer 12 a parameter to use for querying insurance information repository 22 to determine an insurance policy 24l, a policy status 24o and insurance policy limits 24u associated with the parameter. The parameter may be, for example, an insurance policy number or an identification associated with an entity. Insurance verification computer 12 may query insurance information repository 22 to determine an insurance policy 24l, a policy status 24o and insurance policy limits 24u associated with the parameter.

Insurance verification computer 12 may verify that an insurance policy number provided corresponds to a valid insurance policy for the entity applying for the title, tag or vehicle registration. Insurance verification computer 12 may also confirm whether the insurance policy meets state requirements. Insurance verification computer 12 may send to government computer 14 insurance information including an insurance policy 24l, a policy status 24o and insurance policy limit 24u. Government computer 14 may receive the insurance information and if the insurance policy is active, government computer 14 receives a verification message stating that the proof of insurance presented is legitimate, i.e., it is not a false or inactive insurance policy.

In another exemplary embodiment, insurance verification computer 12 may send to government computer 14 a message stating that an entity has reinstated an insurance policy that was cancelled or had expired. For example, the message may include insurance information such as, insurance coverage 24r and a policy effective date 24m of an insurance policy. The government and the police records may be automatically updated with the insurance information. Currently, the insurance company notifies the government and/or the police of a reinstatement of insurance by mail. As such, it may take weeks before the government and police records are updated. Having up-to-date records may prevent a police officer from erroneously arresting a driver because the out-of-date police records indicate that the driver has not reinstated their vehicle insurance policy.

In another exemplary embodiment, a law enforcement agent may send a request for insurance information, such as to verify whether an insurance policy is active, to insurance verification computer 12 using government computer 14, which may be installed in a police car. If insurance verification computer 12 determines that the insurance policy is active, insurance verification computer 12 may send to government computer 14 verification of the legitimacy of the insurance policy provided by the driver. Otherwise, if insurance verification computer 12 determines that the insurance policy is inactive or is a false insurance policy, insurance verification computer 12 may send an alert message to government computer 14. The police officer may see the message and may decide to write a ticket to the driver for driving without insurance. The number of tickets issued for driving without insurance may increase due to the law enforcement agent having the ability to verify in real time whether a driver has an active insurance policy. Increasing the number of tickets issued may increase the revenue of the police department.

Insurance verification computer 12 may further determine whether the insurance policy limits 24u comply with a state minimum insurance requirement. Government computer 14 may send to insurance verification computer 12 a request to verify whether an insurance policy associated with a parameter complies with a state minimum insurance requirement. Government computer 14 may send to insurance verification computer 12 a parameter that, for example, identifies an insurance policy or an entity. The parameter is used by insurance verification computer 12 to query insurance information repository 22 and determine whether the insurance policy limits 24u associated with the parameter comply with a state's standards. Insurance verification computer 12 may include a list of the minimum insurance requirement for each state.

Insurance verification computer 12 may query insurance information repository 22 to determine the insurance policy limits 24u associated with the parameter. Insurance verification computer 12 may compare insurance policy limits 24u with a corresponding state minimum insurance requirement. Insurance verification computer 12 may send to government computer 14 an indication that the insurance policy does or does not comply with the minimum standards set by the government. For example, if the insurance policy limits 24u are at least equal to the minimum state requirement, then insurance verification computer 12 may send to government computer 14 a message indicating that the insurance policy has an insurance policy limit that complies with the minimum state requirement. Otherwise, if the insurance policy limits 24u are less than the minimum state requirement, insurance verification computer 12 may send a warning message to government computer 14 stating that the insurance policy does not comply with the state minimum insurance requirements. Insurance verification computer 12 may also send to government computer 14 insurance policy limits 24u. The law enforcement officer may see the message on government computer 14 and may write a ticket to a driver for having insurance that does not comply with the state minimum insurance requirements.

In another exemplary embodiment, insurance verification computer 12 may send insurance information to a tax collector office so that government computer 14 may calculate taxes owed. For example, government computer 14 may send a request to insurance verification computer 12 requesting a name of a beneficiary for a life insurance policy that has been claimed. The request may include a parameter identifying a life insurance policy. Insurance verification computer 12 may send to government computer 14 a name of a beneficiary 24i of the life insurance policy.

In another exemplary embodiment, insurance verification computer 12 may determine whether a person qualifies to work for the government or qualifies to receive benefits and assistance from a government agency. For example, government computer 14 may request insurance verification computer 12 to send to government computer 14 medical information 24d associated with a person who wishes to apply for the military. Insurance verification computer 12 may receive the request for medical information including a parameter that identifies a person. Insurance verification computer 12 may query insurance information repository 22 using the parameter. Insurance verification computer 12 may determine medical information 24d associated with the parameter and may send the medical information 24d to government computer 14. Insurance verification computer 12 may analyze the medical information 24d and may alert government computer 14 when a person is not qualified to receive benefits or assistance from the government agency.

In another exemplary embodiment, insurance verification computer 12 may send a policy update to an entity when an insurance policy has been updated. For example, insurance verification computer 12 may receive from insurance carrier computer 16 a message indicating that changes have been made to the terms of an insurance policy. An insurance policy update may affect, for example, all life insurance policies. Insurance verification computer 12 may send an update message to the entities associated with the updated insurance policies. The message may notify the entities of the update and may include the new terms of the insurance policy.

In an exemplary embodiment, insurance verification computer 12 may store insurance information including an insurance policy timeline. The timeline may indicate a continuity or discontinuity in time between insurance policies. The timeline may also indicate a date when changes were made to an insurance policy. For example, the timeline may indicate that an insurance policy was updated last year to include uninsured motorist coverage. The timeline may further indicate whether an entity had prior insurance coverage. A requestor may query insurance verification computer 12 to determine whether an entity had prior insurance coverage.

In another exemplary embodiment, insurance verification computer 12 may receive an insurance information request message from a third party computer, such as insurance carrier computer 16, to return the names of people associated with a particular address. The insurance information request message may include an address and a request to determine insurance information associated with the address. Processor 26 may be configured to search insurance information repository 22 using the address. Processor 26 may determine entities whose address 24b matches that particular address. Determining that more than one entity is associated with an address may alert a third party computer that one of the entities may be committing insurance fraud.

Processor 26 may retrieve, from insurance information repository 22, insurance information associated with the address, the insurance information including at least one entity identification associated with the address. Transmitter 52 in insurance verification computer 12 may be configured to transmit to the third party computer, e.g., to insurance carrier computer 16, the insurance information associated with the address. The insurance information associated with the address may include the names of people who have used that particular address in an insurance policy application. Insurance verification computer 12 may determine a number of people associated with the particular address. If the number of people who have used the address is higher than a predetermined threshold, insurance verification computer 12 may send an alert to the third party computer, e.g., insurance carrier computer 16. For example, in an insurance application, a person may list as their primary residence address the address of a family member or a friend (instead of their own primary residence address) in order to get a lower insurance premium. This type of insurance fraud may occur in situations when the person lives in an area where the insurance rates are higher than in the area where the family member or friend lives. If many related people are associated with the address, it may be possible that the people do no really live at the address, but instead, use the address to get lower insurance premiums.

In another exemplary embodiment, financial institution computer 18 may request from insurance verification computer 12 a list of all addresses associated with a parameter, where the parameter may be associated with an entity, an asset or an insurance policy. The financial institution may start a repossession process of an asset by compiling addresses associated with an entity or the asset. An entity may be aware of the possible repossession of the asset, and may decide to store/hide the asset at a different address than the entity's address. When repossessing an asset, the financial institution may send repossession personnel to all of the addresses on the list, as the asset may be located/hidden at an address different from the address on the entity's loan application.

In another exemplary embodiment, insurance verification computer 12 may continuously monitor newly uploaded insurance policies in order to analyze the addresses associated with the new insurance policies. Insurance verification computer 12 may determine whether an address associated with a newly uploaded insurance policy is the same as an address listed in an already existing insurance policy associated with a different entity. When insurance verification computer 12 determines that a new insurance policy lists an address that is already stored in insurance information repository 22 and is associated with a different entity, insurance verification computer 12 may send a warning message to insurance carrier computer 16. The warning message may include an insurance policy number corresponding to the different entity.

In another exemplary embodiment, insurance verification computer 12 may send a text message or an email to an entity when a third party computer requests additional insurance information in order to maintain a certain benefit. For example to keep an insurance policy active, maintain driving privileges, etc. For example, an entity may receive an insurance information request message when their insurance policy may be about to become inactive (expired or cancelled). Receiver 54 may be configured to receive, from the third party computer, an insurance information request message. The insurance information request message may include a parameter associated with an entity and a request to alert the entity that additional insurance information from the entity is required in order to maintain a certain benefit, such as maintaining their driving privileges or maintaining an insurance policy active. Memory 36 may be configured to store the insurance information request message in insurance information repository 22 so that the insurance information request message can be accessed by the entity. Transmitter 52 may be configured to transmit the insurance information request message to the entity via, for example, text message or email. The text message or email message may include, for example, instructions as to how to avoid losing a benefit, such as how to avoid expiration or cancellation of the insurance policy. For example, insurance verification computer 12 may determine which insurance policies are associated with a policy expiration date 24n of next week. Insurance verification computer 12 may send an insurance information request message to entities associated with the insurance policies.

In another exemplary embodiment, insurance verification computer 12 may receive from insurance carrier computer 16, a request to send a notification to all people associated with insurance policies that are about to expire or get cancelled. Insurance verification computer 12 may receive a parameter from insurance carrier computer 16 that includes one or more insurance policy numbers that are about to become inactive. Insurance verification computer 12 may search insurance information repository 22 to determine contact information associated with the one or more insurance policy numbers. Insurance verification computer 12 may send insurance information request messages to the persons whose insurance policy is about to expire. Having insurance verification computer 12 send the insurance information request messages may allow people to be notified promptly when their insurance policy is about to become inactive. In this way, the insurance company does not have to rely on the mail service or rely on insurance agents to deliver the expiration and cancellation notifications to the affected entities. Otherwise, the notification may get lost in the mail, may never get delivered, or may not be delivered on time.

In another exemplary embodiment, a requester may query insurance information repository 22 directly. The requester may query insurance information repository 22 directly instead of requesting insurance verification computer 12 to perform the queries on behalf of the requester. A requester may retrieve insurance information from insurance information repository 22 and may save the insurance information for future use. Alternatively, a copy of insurance information repository 22 may be stored in government computer 14, insurance carrier computer 16 and/or financial institution computer 18.

In another exemplary embodiment, insurance verification computer 12 may store a list of high risk policy holders that have made fraudulent insurance claims. The list may include information associated with policy holders, i.e., entities, who have provided false or misleading information in order to obtain an insurance policy. For example, the list may include a name or an identification associated with a policy holder that has (i) filed a false injury report, (ii) filed a claim with two different insurance companies (“double dipping”), or (iii) committed any type of insurance fraud. High risk policy holders may be associated with insurance policies that have a high likelihood of being fraudulent.

A requester may request insurance verification computer 12 to determine whether an entity is classified as a high risk policy holder, i.e., whether the name or identification of the policy holder is on the list of high risk policy holders. The requester sends to insurance verification computer 12 a parameter, such as a name or identification, associated with an entity. Insurance verification computer 12 will determine whether the parameter, i.e., the name or identification, corresponds to a person on a list of high risk policy holders. If insurance verification computer 12 determines that the name or identification received corresponds to a high risk policy holder, then insurance verification computer 12 sends a warning message to the requester. Otherwise, insurance verification computer 12 sends a message stating that the policy holder is not on the list of high risk policy holders.

FIG. 5 is a flow chart of an exemplary process for verifying insurance information associated with an entity, where the insurance information is stored in insurance information repository 22. An insurance information verification request is received from a third party computer (Block 56). The insurance information verification request includes a parameter associated with the entity. A search of insurance information repository for insurance information associated with the entity is performed. A determination is made as to whether insurance information associated with the entity includes an insurance policy (Block 58). When it is determined that insurance information associated with the entity includes an insurance policy, a policy status of the insurance policy is determined (Block 60) and a verification message verifying that the insurance information associated with the entity includes the insurance policy is transmitted to the third party computer (Block 62). The verification message includes the insurance policy status of the insurance policy. When it is determined that the insurance information associated with the entity does not include an insurance policy, an alert message is transmitted to the third party computer (Block 64). The alert message indicates that the entity does not have insurance.

The present invention can be realized in hardware, software, or a combination of hardware and software. Any kind of computing system, or other apparatus adapted for carrying out the methods described herein, is suited to perform the functions described herein. A typical combination of hardware and software could be a specialized or general purpose computer system having one or more processing elements and a computer program stored on a storage medium that, when loaded and executed, controls the computer system such that it carries out the methods described herein. The present invention can also be embedded in a computer program product, which comprises all the features enabling the implementation of the methods described herein, and which, when loaded in a computing system is able to carry out these methods. Storage medium refers to any volatile or non-volatile storage device.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

1. A method for verifying insurance information associated with an entity, the insurance information stored in an insurance information repository, the method comprising:
receiving, at a receiver and from the third party computer, the insurance information and the parameter associated with the entity, wherein the third party computer is one of a government computer, an insurance carrier computer and a financial institution computer;
storing, at a memory, the insurance information and the parameter in the insurance information repository for future retrieval;
receiving, at the receiver, an insurance information verification request from a third party computer, the insurance information verification request including a parameter associated with the entity;
determining, at a processor, whether insurance information associated with the entity includes an insurance policy;
when the insurance information associated with the entity includes the insurance policy:
determining, at the processor, a policy status of the insurance policy; and
transmitting, at a transmitter and to the third party computer, a verification message verifying that the insurance information associated with the entity includes the insurance policy, the verification message including the policy status; and
when the insurance information associated with the entity does not include the insurance policy:
transmitting, at the transmitter, an alert message to the third party computer, the alert message indicating that the entity does not have insurance;,
determining, at the processor, a risk profile of the entity based at least in part on the insurance information associated with the parameter, the risk profile indicating a risk level associated with the entity;
receiving, at the receiver, a first insurance information request message from the third party computer, the first insurance information request message including the parameter and a request for the risk level associated with the entity based on the parameter;
transmitting, at the transmitter, an alert to the third party computer if the risk level associated with the entity meets a predefined threshold.

2. The method of claim 1,
wherein the risk profile associated with the entity is based at least in part on a number of claims filed by the entity and at least one zip code associated with the entity.

3. The method of claim 1, further comprising
generating a list of high risk policy holders that meet a predetermined risk level;
receiving an insurance information request message from the third party computer, the insurance information request message including the parameter associated with the entity and a request to determine whether the entity is on the list of high risk policy holders;
determining whether the entity is on the list of high risk policy holders based at least in part on the parameter; and
transmitting a message to the third party computer indicating whether the entity is on the list of high risk policy holders.

4. The method of claim 1, further comprising:
receiving a second insurance information request message from the third party computer, the second insurance information request message including the parameter and a request to perform analysis on the insurance information associated with the parameter;
analyzing the insurance information in response to receiving the second insurance information request message, the analysis includes determining the likelihood that an entity associated with the parameter will become involved in an activity that will trigger a claim; and
transmitting the results of the analysis to the third party computer.

5. The method of claim 1, further comprising:
creating an account identifier and a password, the account identifier and the password corresponding to insurance information associated with the entity, the insurance information including the insurance policy;
receiving an insurance information access request from the entity, the insurance information access request including the account identifier and the password; and
providing access to the insurance information to the entity.

6. The method of claim 1, the method further comprising:
determining whether the insurance policy is scheduled to become inactive prior to a predetermined date based at least in part by:
retrieving, from the insurance information repository, a policy expiration date corresponding to the insurance policy; and
comparing the policy expiration date with the predetermined date; and
transmitting a warning message to the third party computer if the insurance policy is scheduled to become inactive before the predetermined date, the warning message including the policy expiration date.

7. The method of claim 1, further comprising:
receiving a second insurance information request message from the third party computer, the second insurance information request message including the parameter associated with the entity, and a request for insurance information corresponding to a prior insurance policy associated with the entity;
determining insurance information corresponding to the prior insurance policy associated with the entity, and a length of time the prior insurance policy was active; and
transmitting the insurance information corresponding to the prior insurance policy associated with the entity, and the length of time the prior insurance policy was active to the third party computer.

8. An insurance verification computer for verifying insurance information associated with an entity, the insurance verification computer comprising:
a transmitter;
a memory in communication with the transmitter, the memory configured to store an insurance information repository that includes insurance information and a parameter associated with the entity;
a receiver, the receiver in communication with the transmitter and the memory, the receiver is configured to:
receive an insurance information verification request from a third party computer, the insurance information verification request including the parameter associated with the entity;
a processor, the processor in communication with the receiver, the transmitter and the memory, the processor configured to determine whether the insurance information associated with the entity includes an insurance policy;
when the processor determines that insurance information associated with the entity includes the insurance policy, the processor further configured to:
determine a policy status of the insurance policy; and
the transmitter configured to transmit to the third party computer, a verification message verifying that the insurance information associated with the entity includes the insurance policy, the verification message including the policy status; and
when the processor determines that insurance information associated with the entity does not include the insurance policy, the transmitter transmits an alert message to the third party computer, the alert message indicating that the entity does not have insurance;
the processor further configured to determine a risk profile of the entity based at least in part on the insurance information associated with the parameter, the risk profile indicating a risk level associated with the entity;
the processor further configured to receive a first insurance information request message from the third party computer, the first insurance information request message including the parameter and a request for the risk level associated with the entity based on the parameter; and
the transmitter further configured to transmits an alert to the third party computer if the risk level associated with the entity meets a predefined threshold.

9. The insurance verification computer of claim 8, wherein
wherein the risk profile associated with the entity is based at least in part on a number of claims filed by the entity and at least one zip code associated with the entity.

10. The insurance verification computer of claim 8, wherein the
the processor is further configured to generate a list of high risk policy holders that meet a predetermined risk level;
the receiver is further configured to receive an insurance information request message from the third party computer, the insurance information request message including the parameter associated with the entity and a request to determine whether the entity is on the list of high risk policy holders;
the processor is further configured to determine whether the entity is on the list of high risk policy holders based at least in part on the parameter; and
the transmitter is further configured to transmits a message to the third party computer indicating whether the entity is on the list of high risk policy holders.

11. The insurance verification computer of claim 8,
wherein the receiver is further configured to receive a second insurance information request message from the third party computer, the second insurance information request message including the parameter and a request to perform analysis on the insurance information associated with the parameter;
the processor is further configured to analyzing the insurance information in response to receiving the second insurance information request message, the analysis includes determining the likelihood that an entity associated with the parameter will become involved in an activity that will trigger a claim; and
the transmitter is further configured to transmits the results of the analysis to the third party computer.

12. The insurance verification computer of claim 8, the processor further configured to create an account identifier and a password, the account identifier and the password corresponding to insurance information associated with the entity, the insurance information including the insurance policy;
the receiver further configured to receive an insurance information access request from the entity, the insurance information access request including the account identifier and the password; and
the transmitter further configured to transmit the insurance information to the entity.

13. The insurance verification computer of claim 8, the processor further configured to determine whether the insurance policy is scheduled to become inactive prior to a predetermined date based at least in part by:
retrieving, from the insurance information repository, a policy expiration date corresponding to the insurance policy; and
comparing the policy expiration date with the predetermined date; and
the transmitter further configured to transmit a warning message to the third party computer if the insurance policy is scheduled to become inactive before the predetermined date, the warning message including the policy expiration date.

14. The insurance verification computer of claim 8, the receiver further configured to receive a second insurance information request message from the third party computer, the second insurance information request message including the parameter associated with the entity, and a request for insurance information corresponding to a prior insurance policy associated with the entity;
the processor further configured to determine insurance information corresponding to the prior insurance policy associated with the entity, and a length of time the prior insurance policy was active; and
the transmitter further configured to transmit the insurance information corresponding to the prior insurance policy associated with the entity, and the length of time the prior insurance policy was active to the third party computer.

15. A system for verifying insurance information associated with an entity, the system comprising:
an insurance information repository, the insurance information repository storing insurance information and a parameter associated with the entity;
an insurance verification computer in communication with the insurance information repository; and
a third party computer in communication with the insurance verification computer, the third party computer comprising:
a third party transmitter, the third party transmitter configured to send an insurance information verification request to the insurance verification computer, the insurance information verification request including the parameter associated with the entity;
the insurance verification computer comprising:
a transmitter;
a receiver, the receiver in communication with the transmitter, the receiver configured to receive the insurance information verification request from the third party transmitter;
a processor, the processor in communication with the receiver and the transmitter, the processor configured to determine whether insurance information associated with the entity includes an insurance policy;
when the processor determines that the insurance information associated with the entity includes the insurance policy, the processor is further configured to:
determine a policy status of the insurance policy; and
the transmitter is configured to transmit to the third party computer, a verification message verifying that the insurance information associated with the entity includes the insurance policy, the verification message including the policy status; and
when the processor determines that insurance information associated with the entity does not include the insurance policy, the transmitter is configured to transmit an alert message to the third party computer, the alert message indicating that the entity does not have insurance;
the processor further configured to determine a risk profile of the entity based at least in part on the insurance information associated with the parameter, the risk profile indicating a risk level associated with the entity;
the processor further configured to receive a first insurance information request message from the third party computer, the first insurance information request message including the parameter and a request for the risk level associated with the entity based on the parameter; and
the transmitter further configured to transmits an alert to the third party computer if the risk level associated with the entity meets a predefined threshold.

16. The system of claim 15, wherein the
wherein the risk profile associated with the entity is based at least in part on a number of claims filed by the entity and at least one zip code associated with the entity.

17. The system of claim 15, wherein the
the processor is further configured to generate a list of high risk policy holders that meet a predetermined risk level;
the receiver is further configured to receive an insurance information request message from the third party computer, the insurance information request message including the parameter associated with the entity and a request to determine whether the entity is on the list of high risk policy holders;
the processor is further configured to determine whether the entity is on the list of high risk policy holders based at least in part on the parameter; and
the transmitter is further configured to transmits a message to the third party computer indicating whether the entity is on the list of high risk policy holders.

18. The system of claim 15,
wherein the receiver is further configured to receive a second insurance information request message from the third party computer, the second insurance information request message including the parameter and a request to perform analysis on the insurance information associated with the parameter;
the processor is further configured to analyzing the insurance information in response to receiving the second insurance information request message, the analysis includes determining the likelihood that an entity associated with the parameter will become involved in an activity that will trigger a claim; and
the transmitter is further configured to transmits the results of the analysis to the third party computer.

19. The system of claim 15, the processor further configured to create an account identifier and a password, the account identifier and the password corresponding to insurance information associated with the entity, the insurance information including the insurance policy;
the receiver further configured to receive an insurance information access request from the entity, the insurance information access request including the account identifier and the password; and
the transmitter further configured to transmit the insurance information to the entity.

20. A non-transitory computer readable storage medium storing computer readable instructions that when executed by a processor, cause the processor to perform a method comprising:
receiving, from the third party computer, the insurance information and the parameter associated with the entity, wherein the third party computer is one of a government computer, an insurance carrier computer and a financial institution computer;
storing the insurance information and the parameter in the insurance information repository for future retrieval;
receiving an insurance information verification request from a third party computer, the insurance information verification request including a parameter associated with the entity;
determining whether insurance information associated with the entity includes an insurance policy;
when the insurance information associated with the entity includes the insurance policy:
determining a policy status of the insurance policy; and
transmitting, to the third party computer, a verification message verifying that the insurance information associated with the entity includes the insurance policy, the verification message including the policy status; and
when the insurance information associated with the entity does not include the insurance policy:
transmitting an alert message to the third party computer, the alert message indicating that the entity does not have insurance;
determining a risk profile of the entity based at least in part on the insurance information associated with the parameter, the risk profile indicating a risk level associated with the entity;
receiving a first insurance information request message from the third party computer, the first insurance information request message including the parameter and a request for the risk level associated with the entity based on the parameter;
transmitting an alert to the third party computer if the risk level associated with the entity meets a predefined threshold.
